(19) United States
(12) Patent Application Publication
(10) Pub. No.: US 2019/0387729 A1
(43) Pub. Date: Dec. 26, 2019

(54) FISHING LINE RETENTION DEVICE

(71) Applicants: Zakary Pine, Oak Creek, CO (US); Timothy Drummond, Old Creek, CA (US)

(72) Inventors: Zakary Pine, Oak Creek, CO (US); Timothy Drummond, Old Creek, CA (US)

(21) Appl. No.: 16/210,423

(22) Filed: Dec. 5, 2018

Related U.S. Application Data
(60) Provisional application No. 62/661,798, filed on Apr. 24, 2018.

(51) Int. Cl. A01K 97/06; B65H 75/14

(52) U.S. Cl. CPC A01K 97/06; B65H 75/141

(57) ABSTRACT

The present invention sets out to provide an improved way to retain an amount of wound fishing line and the loose end of the wound fishing line to the spool that the fishing line is wound upon. The fishing line retention device comprising of a main circular band having an internal wall, an outer wall and at least one grip tab. The fishing line retention device accurately and tightly holds pressure on the loose end of the fishing line against the spool. The fishing line retention device protects the fishing line from harmful environmental conditions such as wind, water, dirt, sharp objects and UV light.

### RELATED APPLICATION

This application claims priority to provisional patent application U.S. Ser. No. 62/334,798 filed on Apr. 24, 2018, the entire contents of which is herein incorporated by reference.

### BACKGROUND

The present invention relates to an improved system for retaining, storing and protecting fishing line.

Fishing line storage is a problem encountered by all anglers. Fishing line is commonly sold on a spool and requires the angler secure loose line coming off the spool when the desired amount of fishing line has been transferred to a fishing reel or another storage medium. Traditional fishing line spools commonly come with an elastic band which stretches around the fishing line spool, tightening the fishing line against itself and the fishing line spool to prevent the loose end of the fishing line from coming unwound.

Traditional elastic bands are typically a single piece of stretchable nylon sewn at the ends. Furthermore, traditional elastic bands leave a tag or loop of nylon to allow the user to be able to remove the band from the spool. A metal grommet is commonly punched in the middle of the fishing line nylon band wherein the end of the fishing line is fed directly through the metal gromet for angler access. The angler typically then cuts the desired length of fishing line from the total amount of fishing line held on the spool. After cutting the fishing line, the smalls section of the loose end of the fishing line is left protruding out of the metal gromet for quick angler access upon the next use by the angler. Problematically, traditional elastic bands made of nylon lose elasticity over time, resulting in the fishing line becoming unwound from the fishing line spool. Upon the angler returning the re-use the spool of fishing line it is common to have to refeed the fishing line through the metal gromet when the elasticity of the nylon band has been lost. Unwound fishing line cannot easily be transferred to a fishing reel or another storage medium. To prevent anglers from wasting unwound fishing line, which has no use to them, new methods of securing fishing line are needed. Furthermore, traditional nylon bands do not protect or only partially protect from environmental elements such as wind, rain, dirt, and UV light. Furthermore, long durations of expose to water or UV light can physically change the material properties of common fishing line types such as fluorocarbon, monofilament and braided line. Lastly, exposed spools of fishing line are subject to sharp objects can fully or partially cutting the exposed fishing line. As the cost of fishing line rises for the typical consumer, an improved system is needed for fully protecting fishing line spools

### SUMMARY

The present invention sets out to provide an improved way to retain an amount of fishing line and the loose end of fishing line to the spool that the fishing line is wound upon. Unlike traditional nylon bands allowing fishing line to protrude through the band, the fishing line retention device of the current invention allows the loose end of the fishing line wound on a spool to pass underneath and to either side of the main circular band of the fishing retention device. The fishing line retention device is moved by the user grasping the grip tab located on the outer wall of the main circular band and consequently stretches the main circular band to place the internal wall over the fishing line wound onto a fishing line spool. The fishing band retention device offers full protection for the angler's fishing line from environmental elements such as wind, rain, dirt, and UV light by matching the internal width of the spool holding the fishing line being unwound or the majority of the width of the spool holding the fishing line being unwound. A grip tab easily allows an angler to move the fishing retention device onto the spool, off of the spool or to a new position on the spool. Improved materials used to create the fishing line retention device hold there elasticity longer, saving the angler the haste of untangling unwound fishing line and improving the longevity of the fishing line's usable life span. The fishing line retention device creates pressure against the sidewalls of a spool for added line protection and usability. The material used to create the fishing line retention device has shape memory and material properties for providing a reusable device that will hold it's original properties over time.

### BRIEF DESCRIPTION OF THE FIGURES

The detailed description of some embodiments of the invention is made below with reference to the accompanying figures, wherein like numerals represent corresponding parts of the figures.

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 shows an exemplary isometric view of one embodiment of the fishing line retention device.

FIG. 2 shows an exemplary top view of one embodiment of the fishing line retention device.

FIGS. 2A-2E illustrate an exemplary front view of an exemplary embodiment of the fishing line retention device.

FIG. 3 shows an exemplary isometric view of one embodiment of the fishing line retention device mounted onto an exemplary spool.

FIG. 4 shows an exemplary right view of one embodiment of the fishing line retention device mounted to an exemplary spool.

FIGS. 5A-5C illustrate an exemplary cross section view, taken along line 5-5 as shown in FIG. 4, of the fishing line retention device with the spool hidden from view.

FIGS. 5D-5F illustrate an exemplary cross section view, taken along line 5-5 as shown in FIG. 4, of an exemplary spool and of the fishing line retention device mounted thereto.

FIG. 6 shows an exemplary isometric view of one embodiment of the fishing line retention device

### DETAILED DESCRIPTION OF CERTAIN EMBODIMENTS

While preferred embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the disclosure.

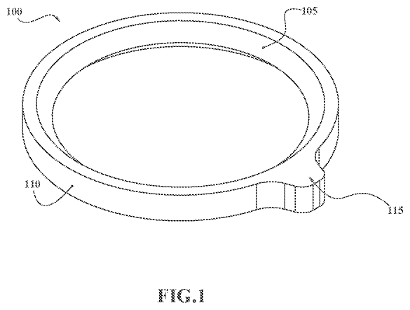

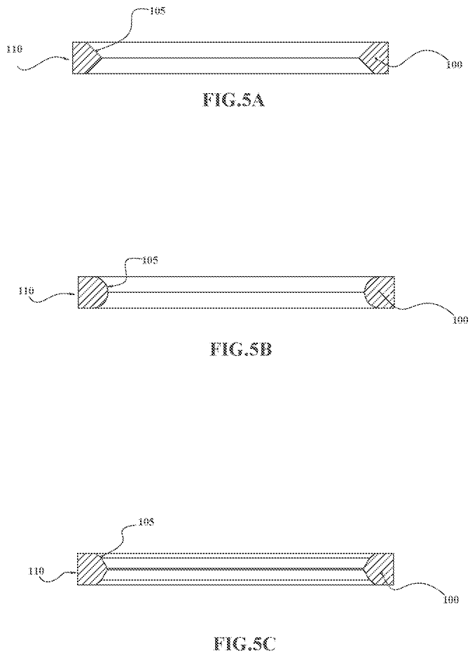

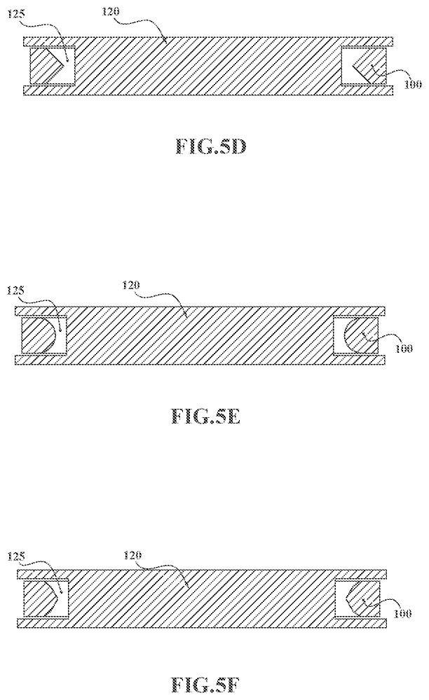

FIG. 1 shows an exemplary isometric view of one embodiment of the fishing line retention device 100. The fishing line retention device 100, in the current embodiment shown in FIG. 1, is a main circular band having an internal wall 105, an outer wall 110 and a grip tab 115. The circular band is stretched and placed over an amount of fishing line 125 wound onto an exemplary spool 120 (as seen in FIG. 5D-5F). The shape of the internal wall is critical for allowing the user or the angler to unwind the fishing line 125 from a spool 120 with the minimal amount of friction imposed on the fishing line 125. Furthermore, when the fishing line undergoes too much friction the result can lead the angler to unwind damaged line. While still not enough friction allows the fishing line to unwind freely. Furthermore, after the fishing line retention device 100 is fitted tightly to the spool 120 or fishing line 125 accurately, the fishing line retention device 100 will not spin inside the spool once fitted properly. The angler or user then cuts the loose end of the wound fishing line 125 to a desired length, the fishing line retention device 100 retains and holds the loose end of the wound fishing line 125 by applying pressure between the fishing line retention device 100, the fishing line 125, and the spool 120 so that fishing line 125 is secured for easy access during future use. In the current exemplary embodiment shown in FIG. 1, the internal wall 105 is a V-shape having two flat sides, as shown in FIG. 1A. This allows for minimal surface area contact at the point of the V-shape between the internal wall 105 of the fishing line retention device 100 and the wound fishing line 125. In some embodiments, the internal wall 105 of the fishing line retention device 100 is a concave shape as shown in FIG. 1B. In some embodiments, the internal wall 105 of the fishing line retention device 100 is a concave shape. In other embodiments, the internal wall 105 can comprise of a least one flat side, as shown in FIG. 5C.

The fishing line retention device 100 can be made of from at least one member of a material set consisting of: a rubber material, a elastomer material, a thermoplastic material, a silicone material, a nitrile material, a vinyl material, and a neoprene material. In some embodiments, the rubber material used to create the fishing line retention device can be, by way of non-limiting example: a neoprene rubber, a Huna-N rubber, a silicone rubber, a EPDM ((ethylene propylene diene monomer) rubber, a natural gum rubber, a Viton rubber, a natural latex rubber, a recycled rubber, a SBR (styrene butadiene) rubber, a vinyl rubber, santoprene rubber, a ECH (epichlorohydrin) rubber, a butyl (isobutylene isoprene) rubber, a latex-free TPE (chlorosulfonated polyethylene) rubber, a hypalon (chlorosulfonated polyethylene) rubber, a hydrogenated nitrile rubber or any other material known to one skilled in the art to have similar elasticity modules.

The fishing line retention device 100 can be manufactured, by way of non-limiting example, by at least one of the following manufacturing processes: a casting process, a CNC (computer numerical control) routing process, a laser cutting process, a stamping processes, a waterjet cutting process, a compression molding process, an injection molding process, and a transfer rubber molding process. In some embodiments, the outer wall of the main circular band further comprises at least one member of an identification set consisting of: an alphanumeric identification, a human user's name, a symbolic shape, a company brand, a numeric identification number, a QR code, a barcode, and an RFID tag. The identification means is used by the angler to quickly determine a characteristic of the fishing line 125 or spool 120. For example, this characteristic could be the following: the manufacturer of the fishing line retention device, the manufacturer of the fishing line, the age of the fishing line, the weight of the fishing line, the diameter of the fishing line, the type of fishing line or the name of the angler. The identification means, in some embodiments, can be incorporated into the fishing line retention device or adjoined to the outer wall 110 of fishing line retention device 100.

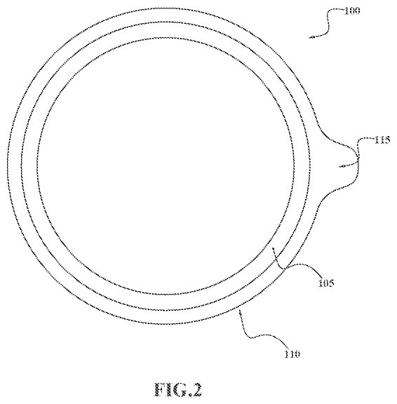

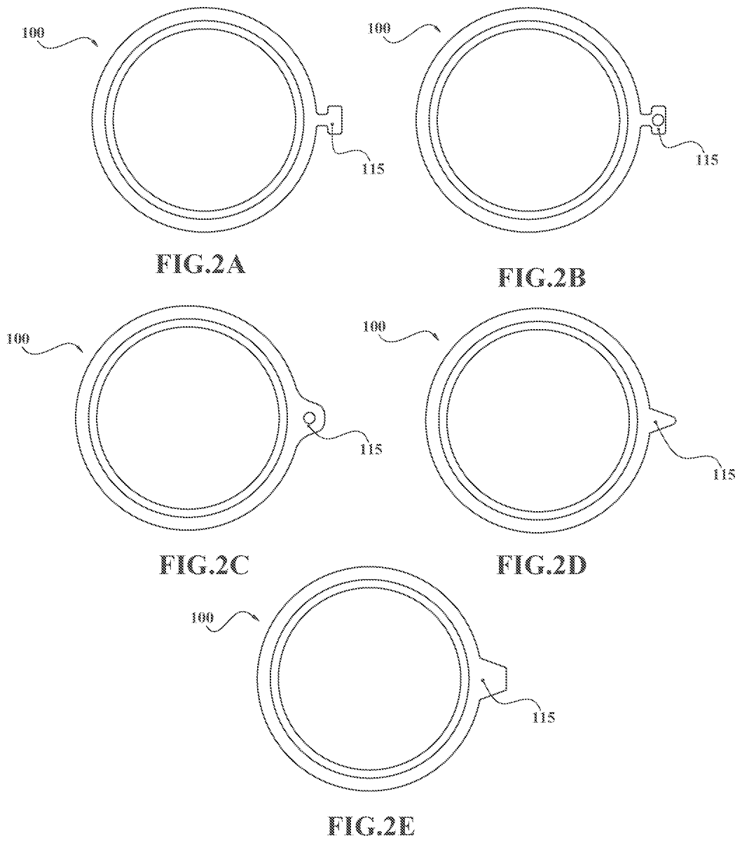

FIG. 2 shows an exemplary top view of one embodiment of the fishing line retention device 100. The fishing line retention device 100 in the current exemplary embodiment has grip tab 115 with rounded edges, as shown in FIG. 2. In different embodiment, the grip tab 115 can comprise of different shapes to assist in the angler or the user in moving the main circular band of the fishing line retention device 100 onto the spool 120, off of the spool 120 or to a new position on the spool 120. By way of non-limiting example, FIGS. 2A-2E illustrate a front view of exemplary embodiments of the fishing line retention device 100 and the grip tab 115. The grip tab 115, in some embodiments, can comprise of a T-shape (as shown in FIG. 2A), a hollow T-shape (as shown in FIG. 2B), a non-rounded shape (as shown in FIG. 2E), a hollow rounded shape (as shown in FIG. 2C) and a cone shape (as shown in FIG. 2D).

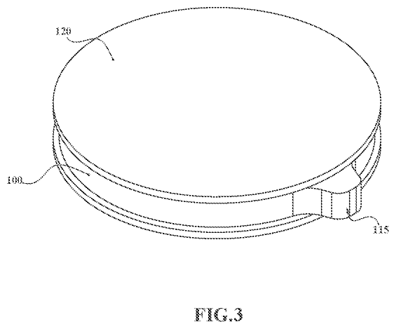

FIG. 3 shows an exemplary isometric view of one embodiment of the fishing line retention device 100 mounted onto an exemplary spool 120. In different embodiments, the fishing line retention device can comprise of different elastic strengths and sizes to match the size, the type of fishing line 125 and the size or type of spool 120. In some embodiments, the width of main band can match the internal width of the spool 120 the fishing line 125 in wound upon. In some embodiments, the width of the band can be less than the internal width of the spool 120 the fishing line 125 in wound upon. The coverage and protection provided by the fishing line retention device 100 for the fishing line 125 wound on spool 120 helps to reduce the chance of accidental line damage or cutting by the angler's line cutting means or on spools with a built-in razor cutter. This is accomplished by keeping the fishing line 125 away from the razor by placing the fishing line 125 on the opposite side of the fishing retention device 100 and consequently, the opposite side of the spool from the side of the spool 120 containing a built-in razor.

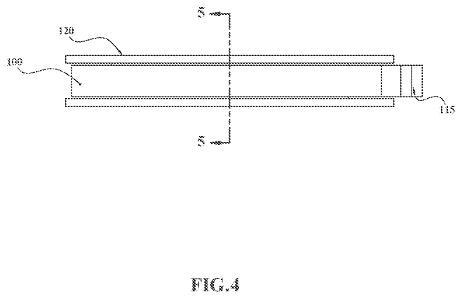

FIG. 4 shows an exemplary right view of one embodiment of the fishing line retention device mounted to a spool 120. FIGS. 5A-5C illustrate an exemplary cross section view, taken along line 5-5 as shown in FIG. 4, of the fishing line retention device 100 with the spool 120 hidden from view. FIGS. 5D-5F illustrate an exemplary cross section view, taken along line 5-5 as shown in FIG. 4, with an exemplary spool 120 and the fishing line retention device 100 mounted thereto. In some embodiments, the spool 120 may require multiple fishing line retention devices 100.

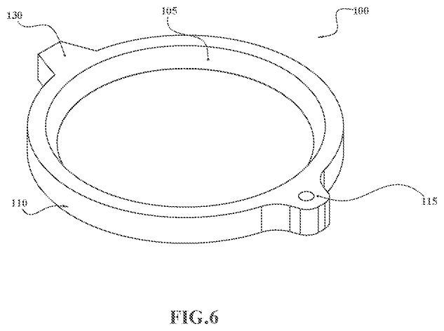

FIG. 6 shows an exemplary isometric view of one embodiment of the fishing line retention device. In some embodiments, the fishing line retention device 100 further comprises a plurality of grip tabs. The plurality of grip tabs can comprise of any exemplary grip tab shape shown in FIGS. 2A-2E. In this embodiment, multiple grip tabs can be used to organize, store, hang or align the spool 120 to a location desired by the user or the angler. For example, the second grip tab 130 can be hollow allowing for a typical retail peg or rod to pass through the fishing line retention device 100, consequently suspending the spool 120 below the retail peg or rod in a retail shopping environment. In some embodiments, multiple grip tabs allow the angler another point of contact with the fishing line retention device 100. In some embodiments, the material used to create the fishing line retention device has a translucent visibility or a semi-transparent visibility. In some embodiments, the fishing line retention device can have various finishes and textures to aide in applying or reducing pressure exerted by the main circular band of the fishing line retention band 100 onto the fishing line 125 held against the spool 120. In some embodiments, the main circular band can have at least one texture of a texture set, by way of non-limiting example, consisting of: a grit texture, a rough texture, a slotted texture, a waffle texture, a ribbed texture, a slotted texture, a stamped texture and a wavy texture.

As used in this application, the term “a” or “an” means “at least one” or “one or more.”

As used in this application, the term “about” or “approximately” refers to a range of values within plus or minus 10% of the specified number.

As used in this application, the term “substantially” means that the actual value is within about 10% of the actual desired value, particularly within about 5% of the actual desired value and especially within about 1% of the actual desired value of any variable, element or limit set forth herein.

All references throughout this application, for example patent documents including issued or granted patents or equivalents, patent application publications, and non-patent literature documents or other source material, are hereby incorporated by reference herein in their entireties, as though individually incorporated by reference, to the extent each reference is at least partially not inconsistent with the disclosure in the present application (for example, a reference that is partially inconsistent is incorporated by reference except for the partially inconsistent portion of the reference).

Unless otherwise defined, all technical terms used herein have the same meaning as commonly understood by one of ordinary skill in the art to which this disclosure belongs.

As used herein, the singular forms “a,” “an,” and “the” include plural references unless the context clearly dictates otherwise. Any reference to “or” herein is intended to encompass “and/or” unless otherwise stated.

As used herein, the term “about” refers to an amount that is near the stated amount by about 0%, 5%, or 10%, including increments therein.

Unless otherwise defined, all technical terms used herein have the same meaning as commonly understood by one of ordinary skill in the art to which this disclosure belongs.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

Any element in a claim that does not explicitly state “means for” performing a specified function, or “step for” performing a specified function, is not to be interpreted as a “means” or “step” clause as specified in 35 U.S.C. § 112, ¶6. In particular, any use of “step of” in the claims is not intended to invoke the provision of 35 U.S.C. § 112, ¶6.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A fishing line retention device for retaining an amount of fishing line to a spool; the fishing line retention device comprising:
a main circular band, having an internal wall and an outer wall; wherein the main circular band contacts the spool and the internal wall contacts a fishing line wound on a spool;
a grip tab, adjoined to the outer wall of the main circular band; wherein a user can move the main circular band by grasping the grip tab.

2. The fishing line retention device of claim 1, wherein the internal wall is shaped to have at least one flat side.

3. The fishing line retention device of claim 1, wherein the internal wall is a concave shape.

4. The fishing line retention device of claim 1, wherein the internal wall is a convex shape.

5. The fishing line retention device of claim 1, wherein the grip tab is hollow.

6. The fishing line retention device of claim 1, wherein the fishing line retention device further comprises a plurality of grip tabs.

7. The fishing line retention device of claim 1, wherein the main circular band is made from at least one member of a material set consisting of: a rubber material, an elastomer material, a thermoplastic material, a silicone material, a nitrile material, a vinyl material, and a neoprene material.

8. The fishing line retention device of claim 1, wherein the outer wall of the main circular band further comprises at least one member of an identification set consisting of: an alphanumeric identification, a human user's name, a symbolic shape, a company brand, a numeric identification number, a QR code, a barcode, and an RFID tag.

9. The fishing line retention device of claim 1; wherein the main circular band is devoid of contact with the spool.

10. The fishing line retention device of claim 1; wherein the main circular band is textured.
